(19) United States
(12) Patent Application Publication
(10) Pub. No.: US 2012/0236049 A1
(43) Pub. Date: Sep. 20, 2012

(54) COLOR-DEPENDENT WRITE WAVEFORM TIMING

(75) Inventors: Mark M. Todorovich, San Diego, CA (US); Koorosh Aflatooni, Cupertino, CA (US); Nao S. Chuei, San Mateo, CA (US)

(73) Assignee: QUALCOMM MEMS Technologies, Inc., San Diego, CA (US)

(21) Appl. No.: 13/158,059

(22) Filed: Jun. 10, 2011

Related U.S. Application Data
(60) Provisional application No. 61/453,057, filed on Mar. 15, 2011.

(51) Int. Cl. G09G 5/02

(52) U.S. Cl. 345/694; 345/690

(57) ABSTRACT

This disclosure provides systems, methods and apparatus including computer programs encoded on computer storage media, for driving a pixel of a display. In one aspect, a common driver may be configured to write data to different display elements in an array of display elements with different line times. By using different line times, a refresh rate of the display may be increased and the response of the display elements to the write waveform may be improved.

### CROSS-REFERENCE TO RELATED APPLICATIONS

This disclosure claims priority to U.S. Provisional Patent Application No. 61/453,057, filed Mar. 15, 2011, entitled “COLOR-DEPENDENT WRITE WAVEFORM TIMING,” and assigned to the assignee hereof. The disclosure of the prior application is considered part of, and is incorporated by reference in, this disclosure.

### TECHNICAL FIELD

This disclosure relates to methods and systems for varying write waveform timing in writing data to an electromechanical display.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Interferometric modulators can be driven by a column and segment driver which write data to lines of display elements. Generally, a refresh rate of the display is a function of the write waveform line time for writing data to the display. An increase in write waveform line time reduces the speed at which images may be displayed. Thus, reduction in the line time required to write data to the display is desirable.

### SUMMARY

The systems, methods and devices of the disclosure each have several innovative aspects, no single one of which is solely responsible for the desirable attributes disclosed herein.

One innovative aspect of the subject matter described in this disclosure can be implemented in a system for driving a display. The system includes a plurality of common lines and a plurality of segment lines connected to an array of display elements, and a common driver configured to drive the plurality of common lines. The common driver can be configured to drive the plurality of common lines to write data to a first set of display elements with a first line time, and write data to a second set of display elements with a second line time. The first line time can be different than the second line time.

Another innovative aspect of the subject matter described in this disclosure can be implemented in a method of writing data to a display. The display includes a plurality of common lines and a plurality of segment lines connected to an array of display elements. The method includes writing data to a first set of display elements of the array with a first line time, and writing data to a second set of display elements of the array with a second line time. The first line time can be different than the second line time.

Another innovative aspect of the subject matter described in this disclosure can be implemented in a system for driving a display including a plurality of common lines and segment lines connected to an array of display elements. The system includes means for writing data to a first set of display elements of the array with a first line time, and means for writing data to a second set of display elements of the array with a second line time. The first line time can be different than the second line time.

Another innovative aspect of the subject matter described in this disclosure can be implemented in a computer program product for processing data for a program configured to drive a display including a plurality of common lines and segment lines connected to an array of display elements. The computer program product includes a non-transitory computer-readable medium having stored thereon code for causing processing circuitry to write data to a first set of display elements of the array with a first line time, and write data to a second set of display elements of the array with a second line time. The first line time can be different than the second line time.

Another innovative aspect of the subject matter described in this disclosure can be implemented in a system for driving a display including a plurality of common lines and a plurality of segment lines connected to an array of display elements. The system includes a common driver configured to drive the plurality of common lines to write data to a first set of display elements with a first line time, and write data to a second set of display elements with a second line time. The first line time and the second line time can be based on a color of the first set of display elements and the second set of display elements.

Another innovative aspect of the subject matter described in this disclosure can be implemented in a method of writing data to a display including a plurality of common lines and a plurality of segment lines connected to an array of display elements. The method includes writing data to a first set of display elements of the array with a first line time, and writing data to a second set of display elements of the array with a second line time. The first line time and the second line time can be based on a color of the first set of display elements and the second set of display elements.

Another innovative aspect of the subject matter described in this disclosure can be implemented in a system for driving a display including a plurality of common lines and segment lines connected to an array of display elements. The system includes means for writing data to a first set of display elements of the array with a first line time, and means for writing data to a second set of display elements of the array with a second line time. The first line time and the second line time can be based on a color of the first set of display elements and the second set of display elements.

Another innovative aspect of the subject matter described in this disclosure can be implemented in a computer program product for processing data for a program configured to drive a display including a plurality of common lines and segment lines connected to an array of display elements. The computer program product includes a non-transitory computer-readable medium having stored thereon code for causing processing circuitry to write data to a first set of display elements of the array with a first line time, and write data to a second set of display elements of the array with a second line time. The first line time and the second line time can be based on a color of the first set of display elements and the second set of display elements.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a diagram illustrating a common driver and a segment driver for driving a color display.

FIG. 10 shows an example of a timing diagram for common and segment signals that may be used to write the frame of display data.

FIG. 11 is an example of a cross-section of a portion of a display.

FIG. 12 shows an example of a timing diagram for common signals that may be used to write the frame of a display.

FIG. 13 shows an example of a timing diagram for common signals that may be used to write the frame of a display.

FIG. 14 shows an example of a flow diagram illustrating a process of writing data to a display.

FIGS. 15A and 15B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Particular implementations of the subject matter described herein include a variable write waveform line time for different display elements in a display. In some aspects, the line time is variable based on the structural differences of the display elements. For example, the line time of a particular display element may be a function of the color of the display element to which data is written.

Particular implementations of the subject matter described in this disclosure can be implemented to realize one or more of the following potential advantages. The time required to write display data may be reduced when compared to drivers known in the art. This may increase the frame rate at which images are displayed. Generally, slow frame rate displays suffer from motion artifacts such as tilting and rubberbanding. For example, assuming a vertical display scan, such that a display screen is scanned from top to bottom, tilting occurs when a vertical line moving on the screen from left to the right will appear to tilt to the right like and be displayed as a partially diagonal line (e.g. “/”). Similarly, a vertical line moving from the right of the screen to the left will appear as a partially diagonal line tilted in the opposite direction (e.g. “\”). Rubberbanding occurs when scrolling text scrolling from the top of the screen to the bottom will appear to be compressed. Conversely, text scrolling from the bottom of the screen to the top of the screen will appear stretched. These effects are a result of the time difference between when the top line of the display is updated and when the bottom line of the display is updated. As the eye integrates these updates, the time delay is interpreted by the brain as the above described motion artifacts. Increasing the frame rate reduces a time difference between updating or refreshing the top and bottom of the display, thereby reducing these artifacts.

Further, the performance of display elements having particular structural configuration may be improved with the same overall update rate for the display. For a given target update rate, it can be useful to allocate line time duration differently for different lines of the display. This can provide more margin for suitable operation for the display elements, and as a result, the yield of the display panels can be improved without reducing frame rate or sacrificing image quality.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

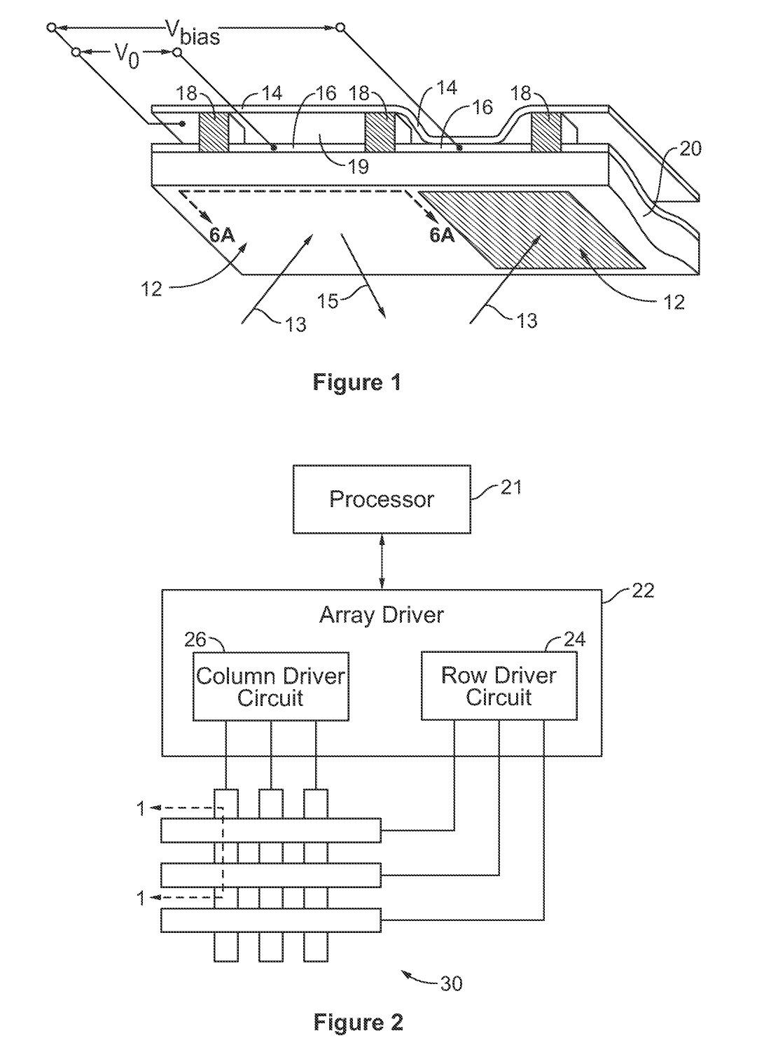

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

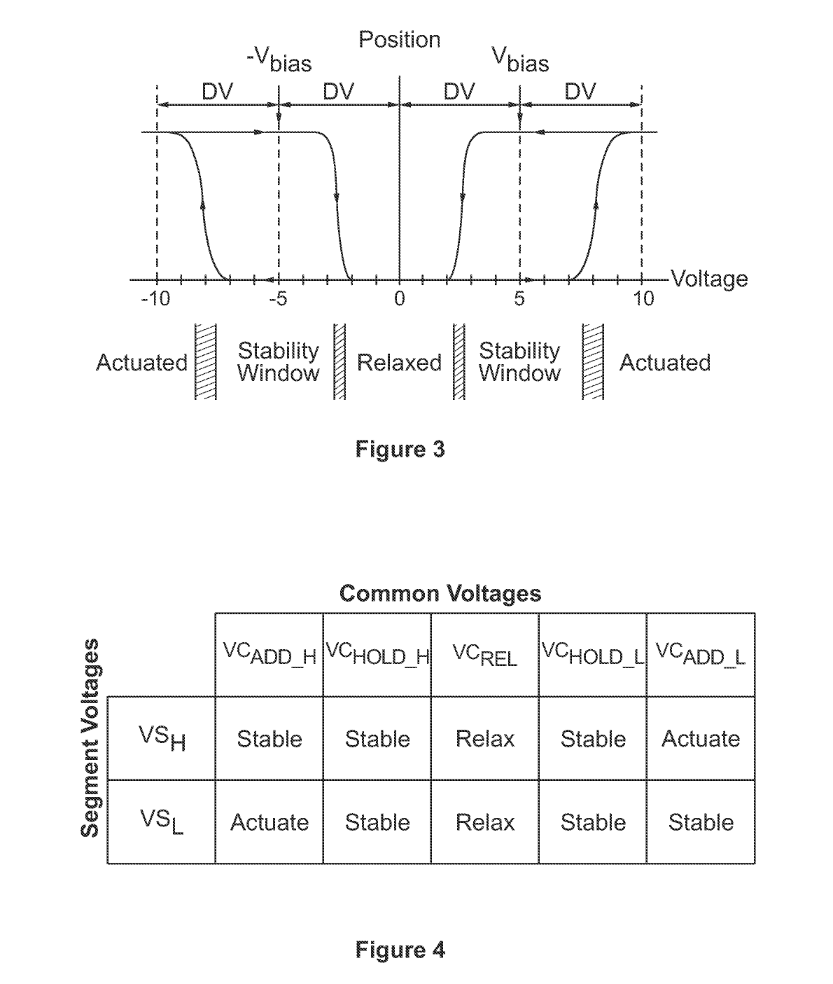

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

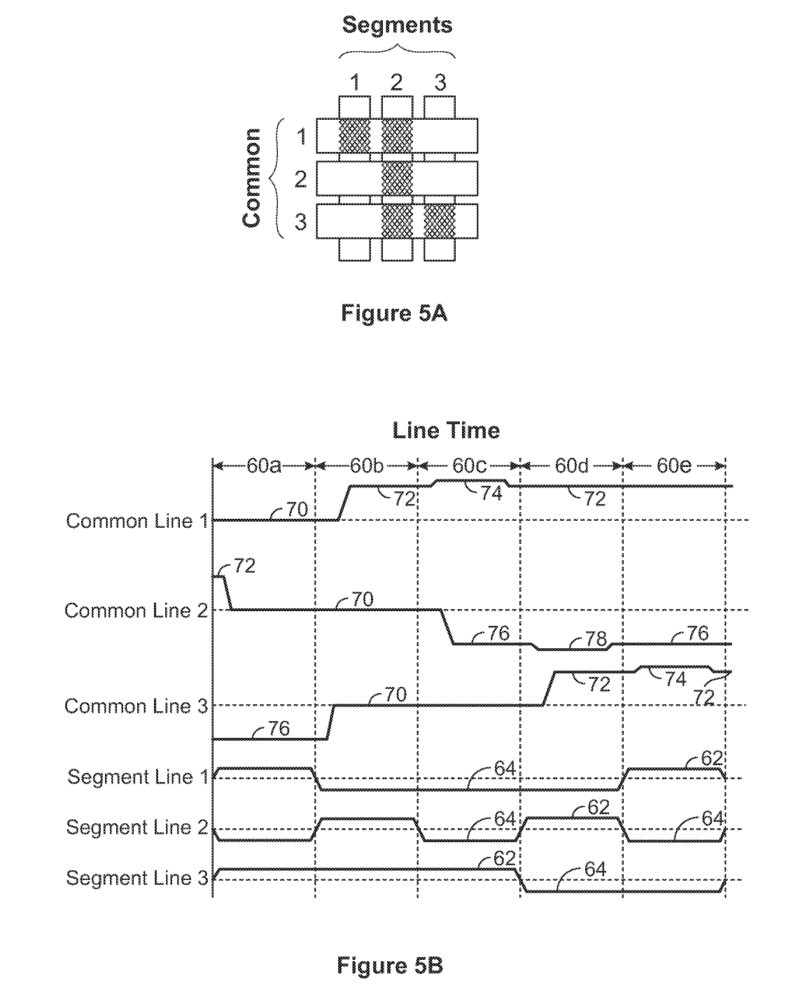

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}−relax and VC_{HOLD}_{_{—}}_{L}−stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

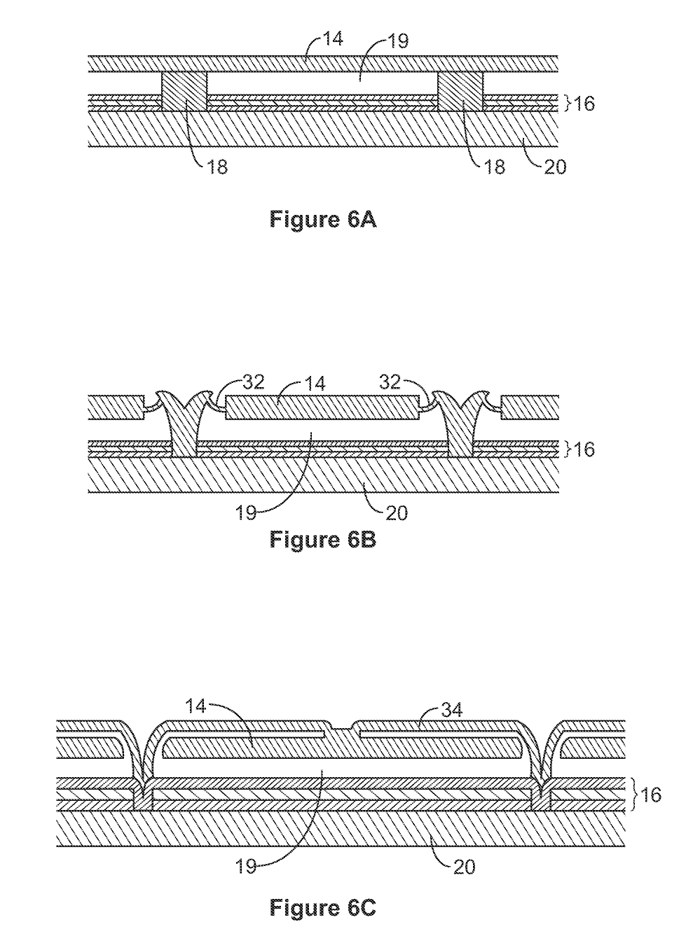

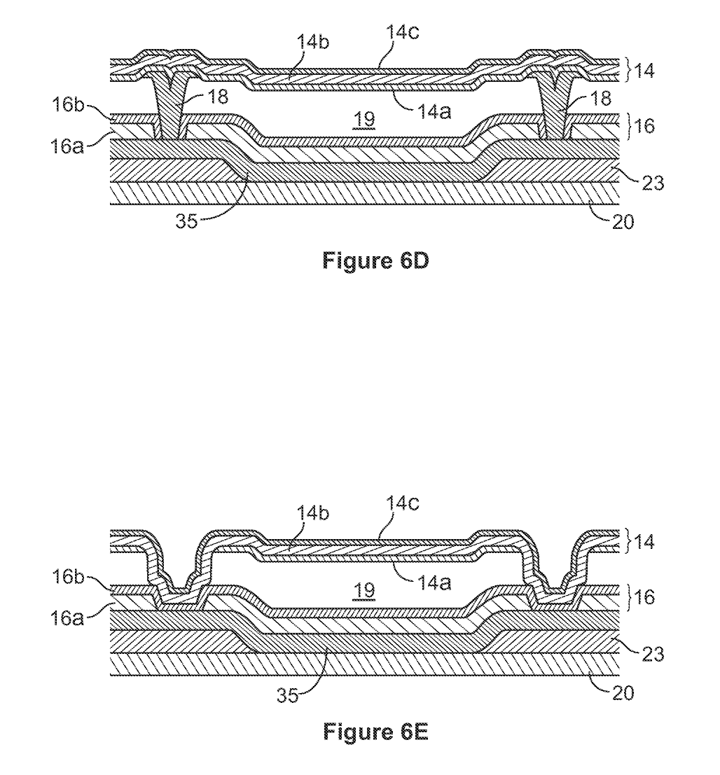

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

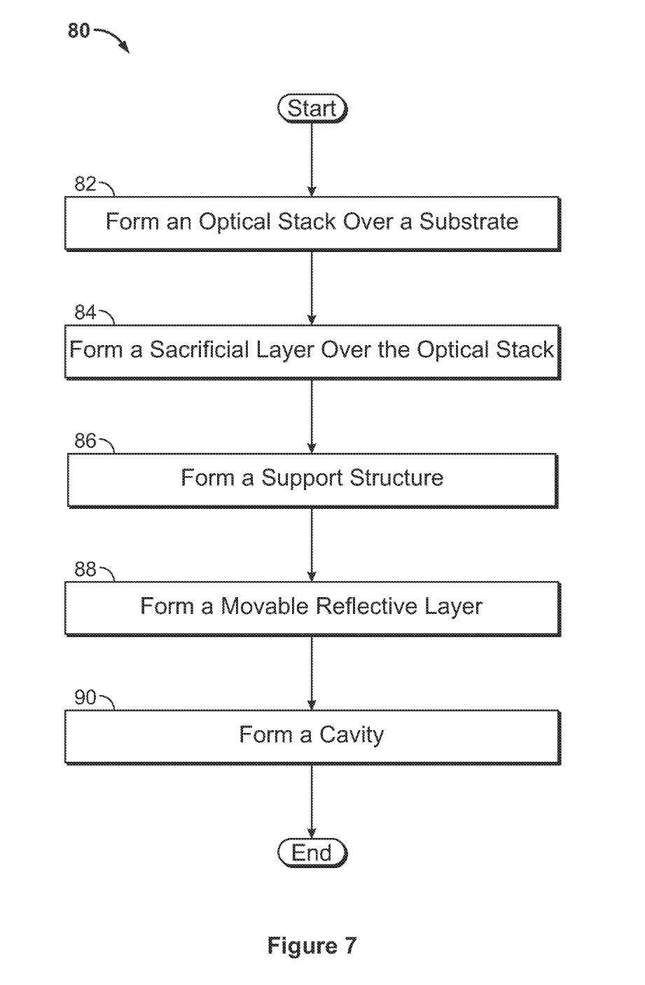

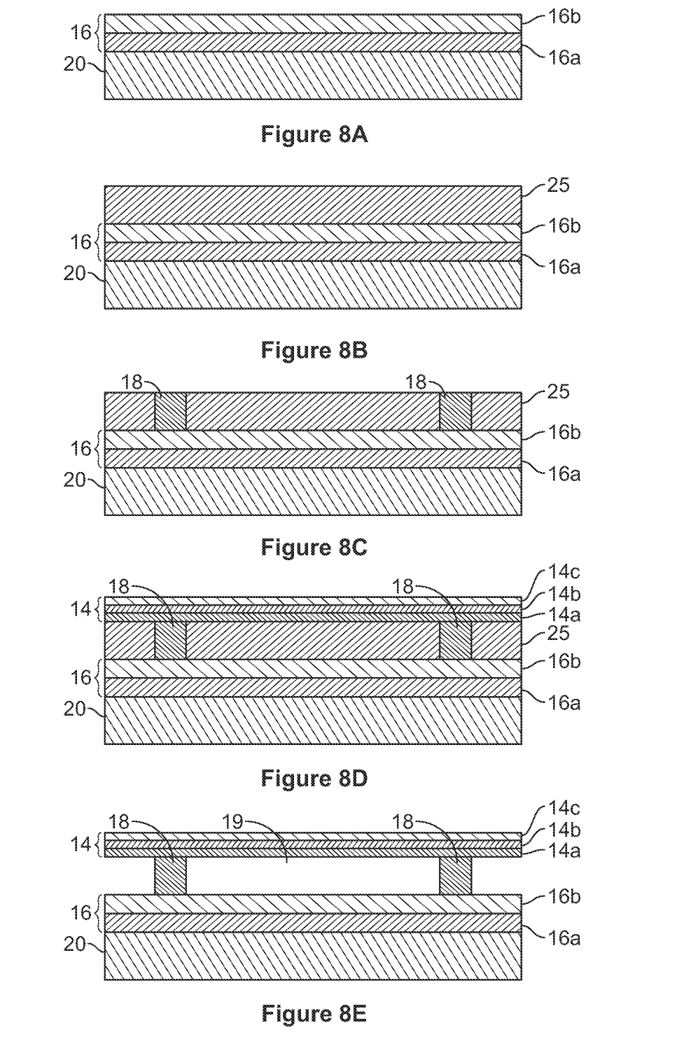

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

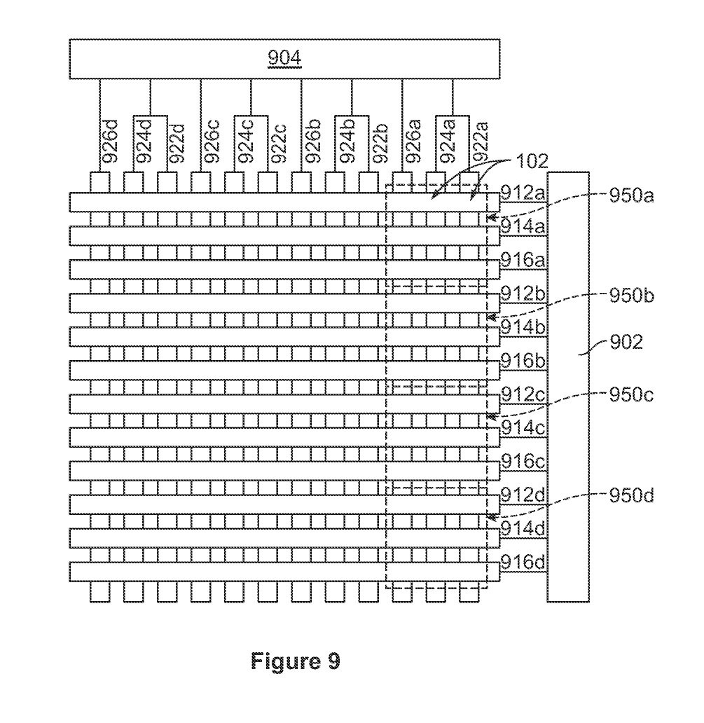

FIG. 9 shows an example of a diagram illustrating a common driver 902 and a segment driver 904 for driving a color display. The color display may include an array of display elements. For example, in the aspect illustrated in FIG. 9, the display includes a plurality of display elements 102 configured to output one or more colors of light. For example, each of the display elements 102 illustrated in FIG. 9 may be configured as an electromechanical display element such as an interferometric modulator, described above.

The common driver 902 and the segment driver 904 may be configured to passively address the display elements 102. For example, the segment driver 904 may be configured to apply “segment” voltages, as described above, to drive lines 922, 924, 926. The common driver 902 may be configured to apply a “common” voltage or signal, as described above, to one of drive lines 912, 914, 916 while the segment voltages are applied to write data to a row of the display elements 102. In this way, the common driver 902 and the segment driver 904 may be used to passively drive the display by sequentially addressing rows of the display elements 102.

As can be seen in FIG. 9, each row of the display elements 102 is associated with one of the drive lines 912, 914, 916. In some aspects, the display elements 102 are grouped so as to form logical pixels such as pixels 950a-950d. In such aspects, the display may include a color display or a monochrome grayscale display. In the illustrated aspect, each pixel 950 comprises nine display elements arranged as three columns by three rows. Thus, for a display configured to be 128 pixels wide by 98 pixels tall, for example, the display may comprise a 384×294 array of display elements.

In some implementations, some of the electrodes of the display may be in electrical communication with one another, such as drive lines 922a and 924a. In such implementations, the same voltage waveform can be simultaneously applied across each of the segment electrodes coupled to these drive lines. Thus, two of the three display elements 102 in each line of a pixel may be driven with the same display data in the illustrated aspect. In some aspects, drive lines that supply data to more than one display element in a row are referred to as most significant bit (MSB) lines, while drive lines that supply data to only one element in a row are referred to as least significant bit (LSB) lines.

In an implementation in which the array includes a color display including a plurality of interferometric modulators, the various colors may be aligned along common lines, such that substantially all of the display elements along a given common line include display elements configured to display the same color. Some implementations of color displays include alternating lines of red, green, and blue subpixels. For example, lines 912 may correspond to lines of red interferometric modulators, lines 914 may correspond to lines of green interferometric modulators, and lines 916 may correspond to lines of blue interferometric modulators. In one implementation, each 3×3 array of interferometric modulators 102 forms one of the pixels 950. In the illustrated implementation in which two of the segment electrodes are shorted to one another, such a 3×3 pixel will be capable of rendering 64 different colors (e.g., a 6-bit color depth), because each set of three common color subpixels in each pixel can be placed in four different states. When using this arrangement in a monochrome grayscale mode, the state of the three pixel sets for each color are made to be identical, in which case each pixel can take on four different gray level intensities. It will be appreciated that this is just one example, and that larger groups of interferometric modulators may be used to form pixels having a greater color range at the cost of overall pixel count or resolution. Further, it will be appreciated that the various colors may be aligned along a column instead of aligned along a row.

As shown in FIG. 9, each row of a pixel may be driven by a separate common drive line. Thus, if there are N rows of logical pixels in the display, the common driver 902 will drive the display elements 102 with 3×N of the drive lines 912, 914, 916. Further, each pixel may be driven by an MSB line and an LSB line, as described above. Thus, if there are M columns of pixels in the display, the segment driver 904 will drive the display elements 102 with 2×M drive lines, where each set of drive lines 922, 924 (such as 922a and 924a) are driven by a common MSB line and the drive lines 926 are driven by a separate LSB drive line.

To latch only one of the colors in the pixel 950, the common driver 902 applies a pulse to the drive line associated with that color. Thus, data may separately be written to each color in the pixel 950, albeit at different times. For example, segment voltages are applied to the MSB line and the LSB line, and then the drive line associated with the top row of the pixel 950a is pulsed to write data to the elements in the top row of the pixel 950a. Thereafter, segment voltages are applied to the MSB line and the LSB line, and the drive line associated with the middle row of the pixel 950a is pulsed to write data to the elements in the middle row. Subsequently, data may be written to the elements in the last row using a similar procedure.

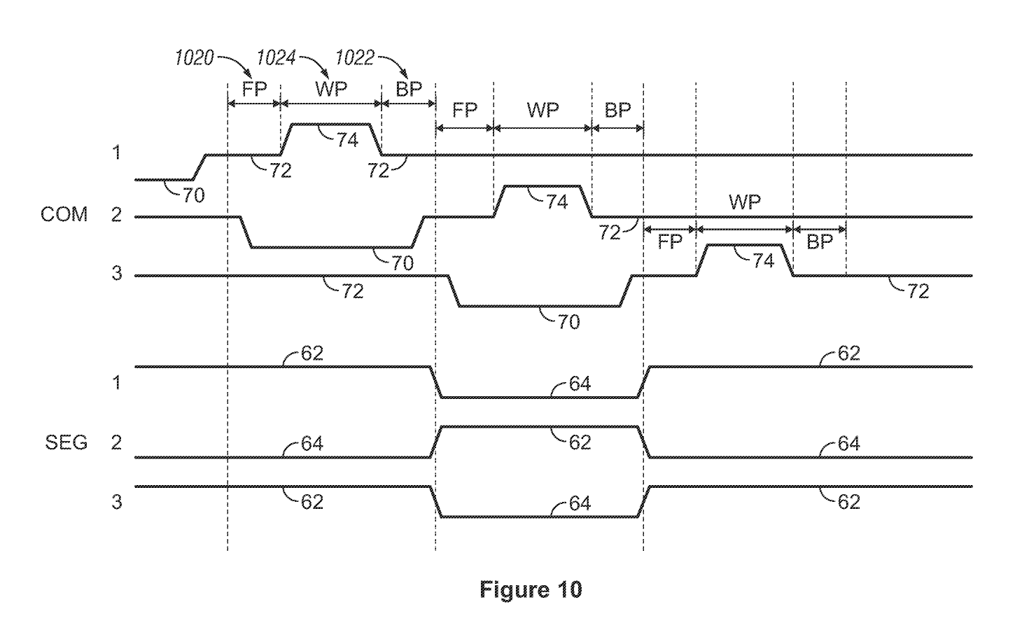

FIG. 10 shows an example of a timing diagram for common and segment signals that may be used to write the frame of display data. The refresh rate of the array of display elements is a function of the amount of time required to write new data to the subpixels without error. This amount of time is may be defined as the line time of each subpixel of the display. A line time includes a front porch (FP), a write pulse (WP), and a back porch (BP). The front porch and back porch are provided in order to avoid error, or false actuation/non-actuation of a subpixel in the array.

For example, a front porch 1020 provides sufficient time for all segment lines to settle to their new state following a SEG transition prior to the application of the write pulse. Similarly, a back porch 1022 is provided such that a COM write pulse may return to a hold state prior to a subsequent SEG transition. Finally, a write pulse time 1024 provides sufficient time to enable actuation of all subpixels on segment lines which are to be actuated by the write pulse. In the example illustrated in FIG. 10, a positive polarity is assumed for driving the display such that the front porch and back porch correspond to a high hold voltage 72 and the write pulse voltage level corresponds to a high address voltage 74. Additionally, as described above, the segment transitions include a low segment voltage 64 and a high segment voltage 62 such that the display element is actuated when a write pulse of a high address voltage 74 is applied and the corresponding segment line is at a low segment voltage 64.

In the driving scheme illustrated in FIG. 10, the line times of each row of the display have equal duration, regardless of the properties of the subpixels in each row. As a result, the refresh rate of the display is the line time times the number of rows of the array. However, as discussed above, the different rows of the array may have structural differences and/or may correspond to different color subpixels. As will be described in greater detail below, subpixels which are configured to display different colors may have structural differences which correspond to a different minimum line time for driving the subpixels.

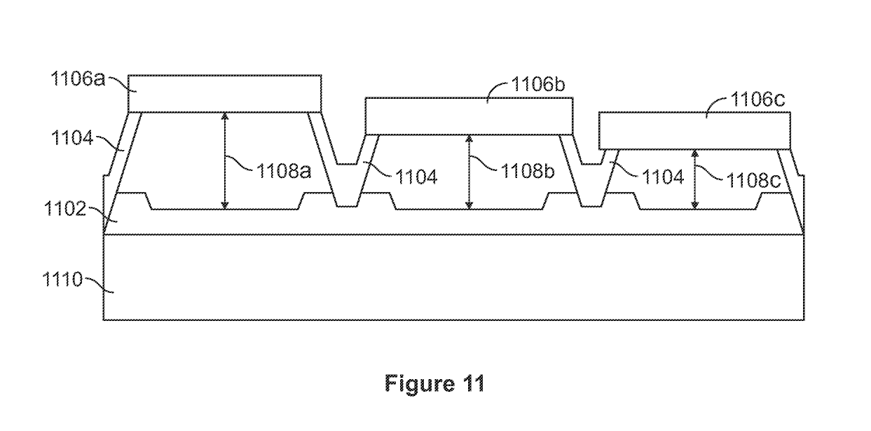

For example, as discussed above with reference to FIG. 9, a first row of subpixels driven with common line 1 may contain only red subpixels. A second and third row may contain only green and blue subpixels, respectively. The different color subpixels display different colors due to different gaps between the electrodes of the subpixel. This is illustrated in FIG. 11, where the subpixel rows extend into the page.

FIG. 11 is an example of a cross-section of a portion of the display. The display includes a substrate 1110 underlying the optical stack. As described above, display element may include a partially reflective and partially transmissive layer (e.g., an absorber) 1102 and a movable element 1106a, 1106b, and 1106c. The optical stack may also include a plurality of dielectric layers (not shown) disposed between the substrate and the optical stack, on either side of the partially reflective and partially transmissive layer 1102, and/or on either side of the movable layers 1106a, 1106b, and 1106c.

Supports 1104 are disposed at corner regions of each subpixel and are configured to support edge portions of the movable elements 1106a, 1106b, and 1106c. Although FIG. 11 omits other layers of the optical stack which are described with reference to FIGS. 6A-6E above (for example, one or more transparent dielectric layers) for clarity, a person/one of ordinary skill in the art will understand that other layers can be present as desired for particular applications.

As illustrated in FIG. 11, gaps 1108a, 1108b, and 1108c are defined between the movable elements 1106a, 1106b, and 1106c and the partially reflective and partially transmissive layer 1102. The gaps 1108a, 1108b, and 1108c may vary between the different movable elements 1106a, 1106b, and 1106c. For example, each display element may have a differently sized gap. In the illustrated example, gap 1106a has a greater height than gap 1106b which has a greater height than gap 1106c.

As discussed above, interference between the light reflected from the partially reflective and partially transmissive layer 1102 and the movable elements 1106a, 1106b, and 1106c will determine the wavelength(s) of light reflected from each subpixel. In turn, each gap height 1108a, 1108b, and 1108c may correspond to a distance which preferentially reflects a particular wavelength of light. For example, gap 1108a may correspond to a red subpixel, gap 1108b may correspond to a green subpixel, and gap 1108c may correspond to a blue subpixel. Alternatively, the blue subpixel may be configured to reflect a second order blue light. In this example, gap 1108a corresponds to the blue subpixel, gap 1108b corresponds to the red subpixel, and gap 1108c corresponds to the green subpixel. One of ordinary skill in the art will recognize that the gap heights are not limited to the above described configurations, and may be varied such that different color subpixels correspond to different gap heights based on the wavelength order of the particular color light reflected by the subpixel.

The different rows of the display elements illustrated in FIG. 11 may be configured and driven in a variety of ways. For example, in some implementations, the stiffness of the movable elements 1106a, 1106b, and 1106c may be different for the different rows. Furthermore, the common drive circuit 902 may be configured to apply different voltage amplitudes for the hold voltages 72 and the actuation voltages 74 for rows of different color display elements.

Still, since subpixels which exhibit different colors have different characteristics, they may have different response times to the application of write pulse and require different minimum write pulse times. Similarly, a suitable front porch and back porch for different color subpixels may be dependent on the color of the subpixel. With a conventional drive scheme, the write pulse, front porch, and back porch are configured, for all color subpixels, to meet the requirements of the color subpixels which require the longest settings in order to ensure proper operation.

In some implementations, different color subpixel rows are driven with driving signals corresponding to different write waveform line times. The line times of each color subpixel row may be configured based on the characteristics of the specific color, and the corresponding physical structure and response time of the particular color subpixel. As a result, an average line time of the display may be reduced, and an overall refresh rate of the display may be improved.

For example, a minimum time corresponding to a write pulse for green subpixels in the array may be less than a minimum time corresponding to a write pulse for red subpixels in the array. In turn, a row including green subpixels may be configured with a shorter line time than a row with red subpixels. Since the line time of the green subpixels in the array is reduced over the conventional drive scheme, the refresh rate of the display is likewise increased.

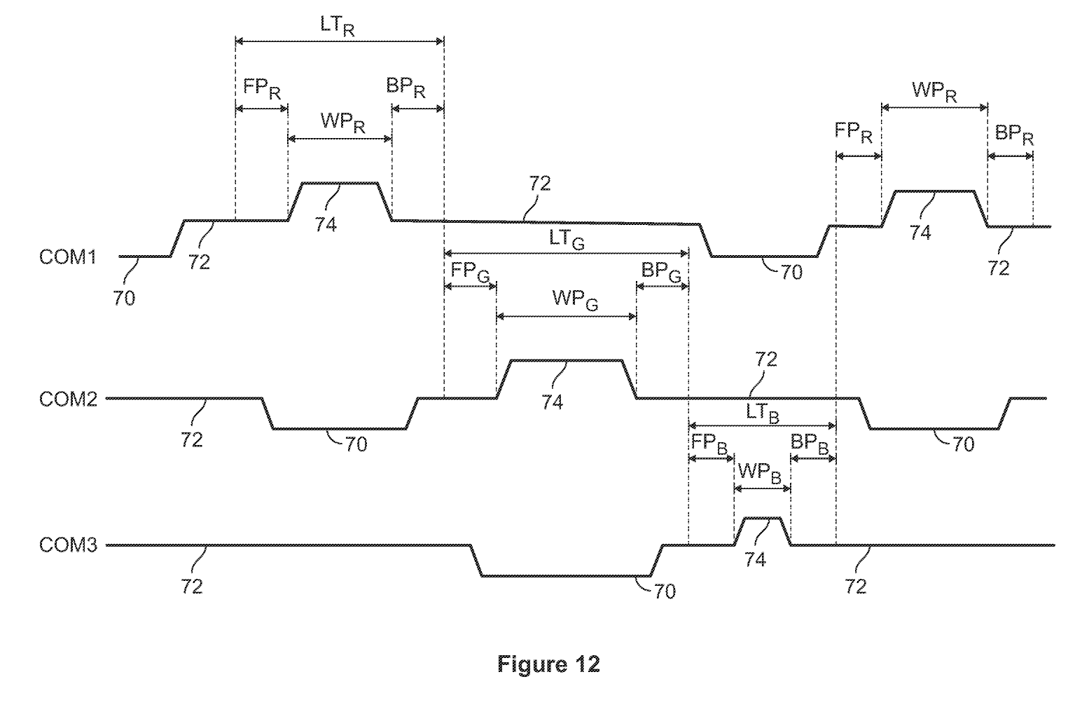

FIG. 12 shows an example of a timing diagram for common signals that may be used to write the frame of a display. As illustrated in FIG. 12, a common driver may be configured to provide the driving signals to the common lines COM1-COM3 such that the line times corresponding to each common line are different. For example, a red subpixel may be driven with a first line time LT_{R}, a green subpixel with a line time of LT_{G}, and a blue subpixel with a line time LT_{B}. Each of the line times LT_{R}, LT_{G}, LT_{B} include a corresponding front porch (FP), write pulse time (WP), and a back porch (BP). As described above, the front porch and the back porch are provided in order to ensure that false actuation or non-actuation of pixels in an array does not take place. The write pulse time is configured to provide the required amount of time to write data to a corresponding pixel. For example, WP_{R} corresponds to an amount of time which is configured to write data to red subpixels in the array.

As illustrated in FIG. 12, a time corresponding to a write pulse for blue subpixels in the array may be less than a time corresponding to a write pulse for green subpixels in the array. In turn, a row including green subpixels may be configured with a longer line time than a row with red subpixels. Similarly, the row of red subpixels is configured to have a longer line time than the row of blue subpixels. Since the line time of the red subpixels and the blue subpixels in the array is reduced over the conventional drive scheme, in which the line time of all rows corresponds to the longest required line time, the refresh rate of the display is likewise increased.

FIG. 12 illustrates an example in which LT_{G} is greater than LT_{R} which is greater than LT_{B}. However, the line times of each of the color subpixels is dependent on the structural differences of the different color subpixels. For example, although a blue subpixel may correspond to a largest gap height 1108a, a red subpixel may correspond to the gap height 1108b, and a green subpixel may correspond to the gap height 1108c, differences in stiffness and structure of the different color subpixels may result in a longer line time for the green subpixel than either the red and the blue subpixels.

Furthermore, FIG. 12 illustrates an example in which each of the write pulse (WP), the front porch (FP) and the back porch (BP) is proportionally reduced in the corresponding line times of the different color pixels. However, the invention is not limited thereto. Any one of the front porch, back porch, and write pulse may be variably reduced based on the configuration and requirements of the different color pixels. For example, FP_{R}, FP_{G} and FP_{B} may be set to equal values corresponding to the longest required front porch among the different color pixels, while WP_{R}, WP_{G}, and WP_{B} may be set differently based on the requirements of the different color pixels. Additionally or alternatively, BP_{R}, BP_{G}, and BP_{B} may be set to correspond to different back porch times or may be set to an equal back porch time.

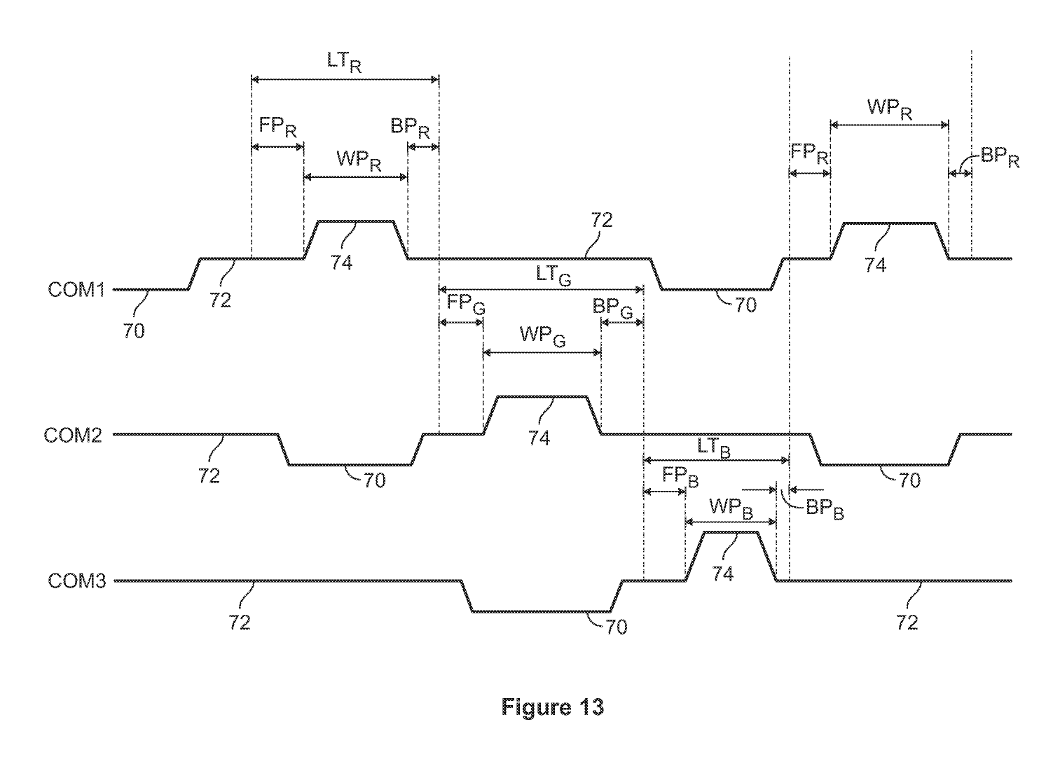

FIG. 13 shows an example of a timing diagram for common signals that may be used to write the frame of a display. In the example illustrated in FIG. 13, line times for each of the different color subpixels may be reduced while maintaining the average line time as the conventional driving scheme. For example a red subpixel may be driven with a line time LT_{R}, a green subpixel with a line time of LT_{G}, and a blue subpixel with a line time LT_{B}. As described above, each of the line times LT_{R}, LT_{G}, LT_{B} include a corresponding front porch (FP), write pulse time (WP), and a back porch (BP).

As discussed above, since the different color subpixels may correspond to different response times based on structural differences, a minimum amount of time for driving the different color subpixels is also variable. According to some implementations, a reduction in the line time for a given row of the display may be used to offset an increase in the line time in another row of the display.

For example, with reference to FIG. 13, a write pulse time WP_{G} corresponding to a green subpixel may be equal to a write pulse time WP_{R} of a red subpixel, which may be less than a write pulse time WP_{B} of a blue subpixel. Additionally, a back porch BP_{G} corresponding to a green subpixel may be less than a back porch BP_{R} of a red subpixel, which may be less than a back porch BP_{B} of a blue subpixel.

According to some implementations, a conventional front porch may correspond to about 8 μs, a conventional write pulse time may correspond to about 40 μs, and a conventional back porch may correspond to about 8 μs for corresponding to a refresh rate frequency of approximately 15 Hz for 384 pixel rows each having a red, green, and blue sub-row. Although this may provide a generally acceptable display appearance, actuation errors are still present, especially in red and green rows. To improve the accurate response in these rows, while maintaining the refresh rate at 15 Hz, the front porch, write pulse time, and back porch illustrated in FIG. 13 may correspond to the values illustrated in the bottom rows of Table 1 below.

TABLE 1

| Driving Scheme | Refresh Rate | | FP | WP | BP | LT |
|---|---|---|---|---|---|---|
| Conventional | Frequency = 15 Hz | | 8 μs | 40 μs | 8 μs | 56 μs |
| Line time | | | | | | |
| Exemplary Line | Frequency = | Red | 8 μs | 44 μs | 5 μs | 57 μs |
| Times | 15 Hz | Green | 8 μs | 44 μs | 8 μs | 60 μs |
| | | Blue | 8 μs | 40 μs | 3 μs | 51 μs |

As shown in Table 1 above, the write pulse times WP_{R} and WP_{G} are greater than the write pulse time WP_{B} and the conventional write pulse time by approximately 4 μs. The increase in write pulse time WP_{R} and WP_{G} allow for improved response of the corresponding red subpixel and green subpixel which exhibit a slower response relative to the blue subpixel. Additionally, the red back porch BP_{R} and the blue back porch BP_{B} are less than the conventional back porch time BP_{S}. The differences in back porch times reduce the risk of false actuation or unintended release based on the structural differences of the different color subpixels. Although the line times corresponding to each particular color subpixel are different, the resulting average line time of the display (57 μs+60 μs+51 μs/3) is equal to the average line time of the conventional driving scheme (56 μs+56 μs+56 μs/3). As a result, an increase in line time for driving subpixels which require a longer line time to ensure an accurate response may be offset by a reduction in the line time of other rows of the array. Therefore, performance of the display may be improved while maintaining the average line time and refresh rate of the display.

A person/one or ordinary skill in the art will recognize that the differences in the waveforms as illustrated in FIGS. 12-13 are not necessarily to scale and may be exaggerated to provide a clearer description. Additionally, while the waveforms have been illustrated based on a common line write pulse having a positive polarity, one of ordinary skill in the art will recognize that the variable write waveforms may also correspond to a negative polarity waveform as described above with reference to FIG. 5B.

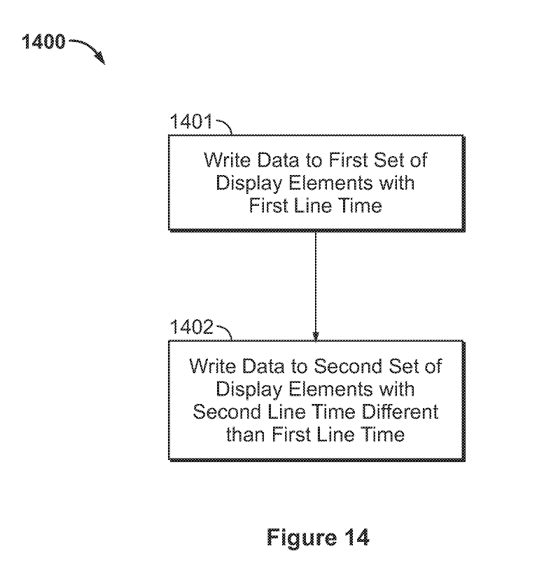

FIG. 14 shows an example of a flow diagram illustrating a process of writing data to a display. As illustrated in FIG. 14, the method 1400 can include writing data to a first set of display elements with a first line time at block 1401. The first set of display elements may, for example, correspond to a row of subpixels in an array of display elements. At block 1402, the method includes writing data to a second set of display elements with a second line time which is different than the first line time. For example, the second set of display elements may correspond to subpixels which are in a second row of the array of display elements.

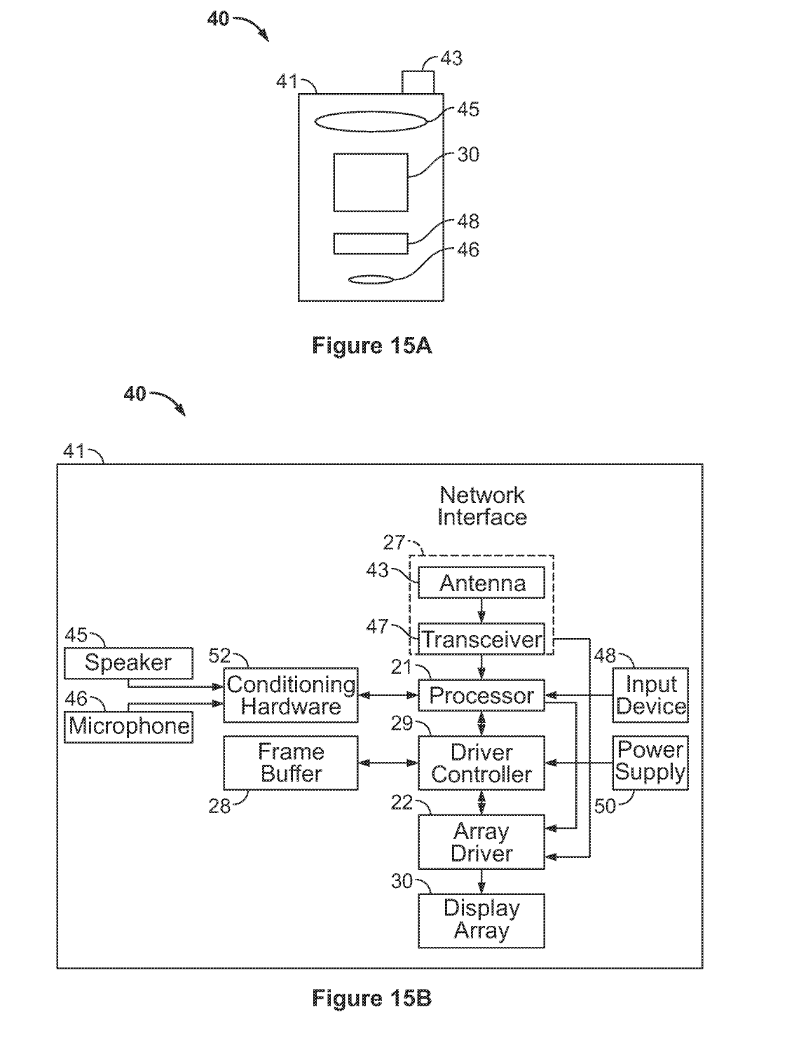

FIGS. 15A and 15B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 15B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A system for driving a display including a plurality of common lines and a plurality of segment lines connected to an array of display elements, the system comprising:
a common driver configured to drive the plurality of common lines to write data to a first set of display elements with a first line time, and write data to a second set of display elements with a second line time, wherein the first line time is different than the second line time.

2. The system of claim 1, wherein the first set of display elements is arranged in a first row of the array, and the second set of display elements is arranged in a second row of the array.

3. The system of claim 1, wherein the common driver is configured to drive a third set of display elements with a third line time, and wherein the third line time is different than the first line time and the second line time.

4. The system of claim 3, wherein the first set of display elements, the second set of display elements, and the third set of display elements correspond to different color subpixels.

5. The system of claim 4, wherein the first set of display elements corresponds to red subpixels, the second set of display elements corresponds to green subpixels, and the third set of display elements corresponds to blue subpixels.

6. The system of claim 5, wherein the second line time is greater than the first line time and the third line time, and wherein the first line time is greater than the third line time.

7. The system of claim 1, wherein the first line time and the second line time include a front porch, a back porch, and a write pulse time, and wherein the second line time is different than the first line time in at least one of the front porch, the back porch, and the write pulse time.

8. The system of claim 1, wherein the first line time and the second line time are determined based on a color of the display elements.

9. The system of claim 1, further comprising:
a display;
a processor that is configured to communicate with the display, the processor being configured to process image data; and
a memory device that is configured to communicate with the processor.

10. The system of claim 1, further comprising:
a driver circuit configured to send at least one signal to the display.

11. The system of claim 10, further comprising:
a controller configured to send at least a portion of the image data to the driver circuit.

12. The system of claim 1, further comprising:
an image source module configured to send the image data to the processor.

13. The system of claim 12, wherein the image source module includes at least one of a receiver, transceiver, and transmitter.

14. The system of claim 1, further comprising:
an input device configured to receive input data and to communicate the input data to the processor.

15. A method of writing data to a display including a plurality of common lines and a plurality of segment lines connected to an array of display elements, the method comprising:
writing data to a first set of display elements of the array with a first line time; and
writing data to a second set of display elements of the array with a second line time, wherein the first line time is different than the second line time.

16. The method of claim 15, wherein the first set of display elements is arranged in a first row of the array, and the second set of display elements is arranged in a second row of the array.

17. The method of claim 15, comprising driving a third set of display elements of the array with a third line time, wherein the third line time is different than the first line time and the second line time.

18. The method of claim 17, wherein the first set of display elements, the second set of display elements, and the third set of display elements correspond to different color subpixels.

19. A system for driving a display including a plurality of common lines and segment lines connected to an array of display elements, the system comprising:
means for writing data to a first set of display elements of the array with a first line time; and
means for writing data to a second set of display elements of the array with a second line time, wherein the first line time is different than the second line time.

20. The system of claim 19, wherein the means for writing data to a first set of display elements and the means for writing data to a second set of display elements comprise a common driver.

21. The system of claim 19, comprising means for writing data to a third set of display elements of the array with a third line time, wherein the third line time is different than the first line time and the second line time.

22. The system of claim 21, wherein the first set of display elements, the second set of display elements, and the third set of display elements correspond to different color subpixels.

23. A computer program product for processing data for a program configured to drive a display including a plurality of common lines and segment lines connected to an array of display elements, the computer program product comprising:
a non-transitory computer-readable medium having stored thereon code for causing processing circuitry to:
write data to a first set of display elements of the array with a first line time; and
write data to a second set of display elements of the array with a second line time, wherein the first line time is different than the second line time.

24. The computer program product of claim 23, comprising code for writing data to a third set of display elements of the array with a third line time, wherein the third line time is different than the first line time and the second line time.

25. The computer program product of claim 24, wherein the first set of display elements, the second set of display elements, and the third set of display elements correspond to different color subpixels.

26. A system for driving a display including a plurality of common lines and a plurality of segment lines connected to an array of display elements, the system comprising:
a common driver configured to drive the plurality of common lines to write data to a first set of display elements with a first line time, and write data to a second set of display elements with a second line time, wherein the first line time and the second line time are based on a color of the first set of display elements and the second set of display elements.

27. The system of claim 26, wherein the first line time is different than the second line time.

28. The system of claim 26, wherein the first set of display elements is arranged in a first row of the array, and the second set of display elements is arranged in a second row of the array.

29. The system of claim 26, wherein the common driver is configured to drive a third set of display elements with a third line time, and wherein the third line time is different than the first line time and the second line time.

30. The system of claim 29, wherein the first set of display elements, the second set of display elements, and the third set of display elements correspond to different color subpixels.

31. The system of claim 30, wherein the first set of display elements corresponds to red subpixels, the second set of display elements corresponds to green subpixels, and the third set of display elements corresponds to blue subpixels.

32. The system of claim 31, wherein the second line time is greater than the first line time and the third line time, and wherein the first line time is greater than the third line time.

33. The system of claim 26, wherein the first line time and the second line time include a front porch, a back porch, and a write pulse time, and wherein the second line time is different than the first line time in at least one of the front porch, the back porch, and the write pulse time.

34. A method of writing data to a display including a plurality of common lines and a plurality of segment lines connected to an array of display elements, the method comprising:
writing data to a first set of display elements of the array with a first line time; and
writing data to a second set of display elements of the array with a second line time, wherein the first line time and the second line time are based on a color of the first set of display elements and the second set of display elements.

35. The method of claim 34, wherein the first line time is different than the second line time.

36. The method of claim 34, wherein the first set of display elements is arranged in a first row of the array, and the second set of display elements is arranged in a second row of the array.

37. The method of claim 34, comprising driving a third set of display elements of the array with a third line time, wherein the third line time is different than the first line time and the second line time.

38. The method of claim 37, wherein the first set of display elements, the second set of display elements, and the third set of display elements correspond to different color subpixels.

39. A system for driving a display including a plurality of common lines and segment lines connected to an array of display elements, the system comprising:
means for writing data to a first set of display elements of the array with a first line time; and
means for writing data to a second set of display elements of the array with a second line time, wherein the first line time and the second line time are based on a color of the first set of display elements and the second set of display elements.

40. The system of claim 39, wherein the first line time is different than the second line time.

41. The system of claim 39, wherein the means for writing data to a first set of display elements and the means for writing data to a second set of display elements comprise a common driver.

42. The system of claim 39, comprising means for writing data to a third set of display elements of the array with a third line time, wherein the third line time is different than the first line time and the second line time.

43. The system of claim 42, wherein the first set of display elements, the second set of display elements, and the third set of display elements correspond to different color subpixels.

44. A computer program product for processing data for a program configured to drive a display including a plurality of common lines and segment lines connected to an array of display elements, the computer program product comprising:
a non-transitory computer-readable medium having stored thereon code for causing processing circuitry to:
write data to a first set of display elements of the array with a first line time; and
write data to a second set of display elements of the array with a second line time, wherein the first line time and the second line time are based on a color of the first set of display elements and the second set of display elements.

45. The computer program product of claim 44, wherein the first line time is different than the second line time.

46. The computer program product of claim 44, comprising code for writing data to a third set of display elements of the array with a third line time, wherein the third line time is different than the first line time and the second line time.

47. The computer program product of claim 46, wherein the first set of display elements, the second set of display elements, and the third set of display elements correspond to different color subpixels.
